(19) United States
(12) Patent Application Publication
(10) Pub. No.: US 2006/0007125 A1
(43) Pub. Date: Jan. 12, 2006

(54) Electronic instructional apparatus

(76) Inventors: Frederick Tsang Lam-tak, Tin Shui Wai (HK); Chi Chow Ka-wah, Shatin (HK); Xia Qi-fang, Tai-Ming Hua Garden (CN); Sannie Chan Lai-shan, Shatin (HK)

Correspondence Address: Howard E. Silverman;GREENBERG TRAURIG, LLP, Ste. 2500, 77 West Wacker Drive, Chicago, IL, 60601, US

(21) Appl. No.: 10/887,278

(22) Filed: Jul. 8, 2004

(51) Int. Cl. G09G 5/00

(52) U.S. Cl. 345/156

(57) ABSTRACT

A user input device for use with an electronic instructional apparatus is disclosed as comprising a plurality of rods supported by a housing, a plurality of switch assemblies positioned along said rods and electrically connected to a control circuit, a plurality of objects rotationally disposed upon the rods and each overlying a switch assembly wherein a flange member within each object contacts and activates a switch when said object is rotated about the axis formed by said rod toward indicating which of the plurality of objects was manipulated by the user.

### BACKGROUND OF THE INVENTION

1. Field of the Invention

This invention relates to electronic learning aids and teaching machines, and particularly, to an electronic instructional apparatus having a user input mechanism suitable for use by an operator who is in a preliterate stage of development, such as a preschool age child. The apparatus according to the present invention is capable of providing response association training in exercises involving phonics as well as letter, number, object and color recognition.

2. The Prior Art

Interactive electronic instructional devices are well known in the prior art. Many of these devices are devoted to the instruction of the above referenced basic skills through the utilization of visual displays and generation of audible sounds which are presented to the child. More complex interactive electronic instructional devices are microprocessor based and typically include a visual display for presenting alphanumeric and/or graphic indicia to the user, a speech synthesis generator for presenting audible words in synthesized human speech, and an input device for accepting a user's response to a prompt generated by the device.

One such prior art device is disclosed in U.S. Pat. No. 4,516,260 issued to Paul S. Breedlove and James H. Moore and assigned to Texas Instruments, Incorporated. The apparatus described therein is capable of making audible presentations to the operator, requiring the operator to provide a response through a keyboard forming part of the apparatus. The apparatus is further capable of operating in a plurality of modes of operation which require the operator to perform a number of different types of spelling and/or associational exercises. Other such prior art devices operate by presenting on a visual display screen viewable by the user a mathematical operation to be solved by inputting a correct response into the apparatus through a keyboard.

Other forms of prior art devices, sometimes referred to as “busy boxes”, include devices directed to infants and/or very young children. Several forms of such prior art devices incorporate speech synthesis features for asking questions or otherwise soliciting responses from the child operator via a synthesized human voice thus requiring that the child operator have at least minimal reading skills, or alternatively, that the child be assisted in using the apparatus by another individual, often the parent.

In order to provide enhanced educational value to a young child interactive educational activities are preferred. Unfortunately, however, many of these types of prior art devices have nevertheless required that the operator have a certain level of intelligence and coordination to operate the device, skills which may exceed that of the typical preliterate child of preschool age.

One potential disadvantage to such prior art interactive educational devices is their reliance upon standard alphanumeric keyboards as input devices. Typically, a preschool aged child is unable to effectively operate a standard adult keyboard due to the young child's lack of manual dexterity and/or coordination. Moreover, a standard “computer style” keyboard is often not visually stimulating to young children who accordingly may become tired of such prior art devices and thus not use and benefit from them.

One prior art device which seeks to avoid some of the disadvantages of traditional computer style keyboard input devices is disclosed is in U.S. Pat. No. 4,968,251 issued to Albert Wai-Kuen Lee, Wei-Kwok Chew and David Tat-Wai Cheung and assigned to Video Technology Electronics Ltd (by change of name VTech Electronics Ltd). The apparatus described therein is capable of making audible presentations to the operator requiring the operator to provide a response through the insertion of loose three-dimensional “answer blocks” into input cavities provided in the apparatus housing. Each answer block has disposed thereon a plurality of display faces bearing indicia representative of potential responses to the presented questions or statements on the sides of the block, such as letters of the English alphabet. Each display face has corresponding peripheral input surfaces which cooperate with detection elements within the input cavities to detect the upward facing surface of the block inserted by the child and, in turn, the response provided by the user. While this apparatus overcomes certain shortcomings in the prior art device's use of a keyboard, it still requires a significant amount of coordination on the part of the child in order to select and insert a physical object into an input cavity within the apparatus housing. Additionally, it is possible that loose pieces may become lost and/or separated thereby precluding use of the product.

Accordingly, it would be desirable to provide an interactive electronic instructional apparatus suitable for use preschool aged, preliterate operator that is both visually stimulating and easily used by children of a young age and development.

It would further be desirable to provide an electronic input device which may be manipulated by young children who lack fully developed coordination skills and which simultaneously teaches phonics, the alphabet, object recognition as well as other educational skills.

It would still further be desirable to provide an instructional apparatus in which the operator presents responses or answers to audibly presented questions by making physical contact with a device in a manner that is appropriate for young children.

It would be yet further desirable to provide an instructional apparatus which is portable and durable and inexpensively constructed.

These and other desirable characteristics of the present invention will become apparent in light of the present application, including the specification, drawings and claims.

### SUMMARY OF THE INVENTION

The present invention comprises a user input device for use with an electronic instructional apparatus including a microprocessor based control circuit, a sound generator for presenting audible sounds, an audio speaker, a power supply and control switches contained within a housing. The user input device comprises a plurality of rods supported by a housing; a plurality of switch assemblies positioned along said rods and electrically connected to the control circuit; a plurality of objects rotationally disposed upon the rods, each object overlying a switch assembly. At least one flange member is provided within each rotational object and is aligned with an associated underlying switch assembly such that the flange contacts and, in turn, activates said switch when said object is rotated about the axis formed by said rod. Accordingly, the control circuit is able to detect which of the plurality of objects is manipulated by the user.

In the preferred embodiment of the invention the shape of the geometric objects are comprised of two half sections that are joined together. Each half has an arcuate cutout of the same radius on two opposing sides which are in alignment with each other. Two rib structures are contained within each half structure and are generally parallel to the two opposing sides of each half structure. The rib structures also have the arcuate cutouts of the same radius as that of the arcuate cutouts at the opposing ends of the half structures. All arcuate cutouts are aligned with each other.

In the preferred embodiment, a rod has a radius that is slightly less than the radius of the cutouts on the opposing sides of the half structures, preferably cubes, and on the reinforcement ribs so as to allow the cube, when assembled, to freely rotate relative to the rod. A concentric sleeve on the rod has a maximum height that is slightly less than the distance from the bottom of the arcuate cutouts (on the opposing sides of the half cubes and on the reinforcement ribs) to the bottom of the half cubes. The sleeve has a width which is slightly less than the distance between the interior walls of the rib structures to prevent linear movement of the assembled cube relative to the rod. An outwardly extending momentary switch is positioned on each sleeve along the rod. At least one flange is disposed within at least one half cube that is parallel to the interior surfaces of the rib structures. The flange has a length and is in alignment with the momentary switch such as to come into contact and depress the momentary switch upon rotation of the cube relative to the rod.

The one rotational object of the preferred embodiment of the present invention includes at least one display surface for displaying indicia viewable by a user. The indicia may comprise letters of the English alphabet. While the objects are generally geometric in shape, non-geometric objects and/or a combination of geometric objects (such as cubes, triangles and spheres) and non-geometric objects (such as animal heads) of the same or varying colors may be provided.

### BRIEF DESCRIPTION OF THE DRAWINGS

FIG. 1 is a front elevation view of the electronic instructional apparatus according to the present invention illustrating six geometric objects, each presenting a forward facing display surface with indicia thereon.

FIG. 2 is an exploded perspective view of two half cubes and one rod having an internal structure that will be described herein.

FIG. 3 is a side cross-sectional view of one of the half cubes and the rod illustrated in FIG. 2 with the rod seated therein.

FIG. 4. is a perspective view of an assembled geometric object in the form of a cube with indicia one display surface.

FIG. 5 is a perspective view of the assembled geometric object in the form of a cube rotated 180 degrees illustrating indicia on the opposing display surface.

FIG. 6 is an alterative embodiment illustrating half of a triangle shaped object with the rod positioned therein.

FIG. 7 is another alternative embodiment illustrating a hemisphere with the rod positioned therein.

### DETAILED DESCRIPTION

While this invention is susceptible of embodiments in different forms, there is shown in the drawings and will be described herein in detail several specific embodiments, with the understanding that the present disclosure is to be considered as an exemplification of the principles of the invention and is not intended to limit the invention to the embodiments illustrated.

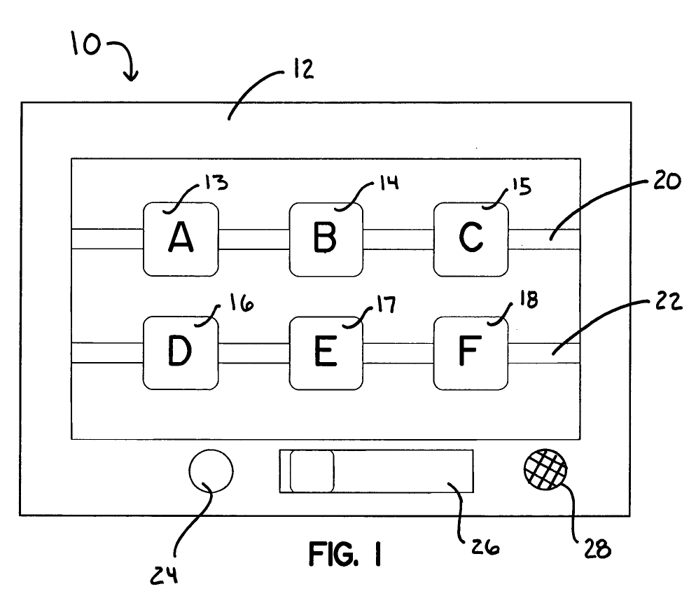

FIG. 1 is a front elevation view of an interactive electronic instructional apparatus 10 incorporating the principles of the present invention. Instructional apparatus 10 is shown comprising housing 12 forming an open frame structure in which electronic circuitry (not shown) supporting operation of the apparatus is contained. Suspended horizontally and spaced apart within housing 12 are rods 20 and 22. Rotationally mounted on rod 20 are geometric objects 13, 14 and 15 which as shown carry the alphabetic indicia “A”, “B” and “C”, respectively. Rotationally mounted on rod 22 are geometric objects 16, 17, and 18 which as shown carry the alphabetic indicia “D”, “E” and “F”, respectively. The apparatus described is illustrated in an abbreviated limited form whereas is it of course contemplated that additional horizontal rods and additional objects would be provided to depict all of the letters of the English alphabet and, perhaps, even decimal numbers, as well as non-geometric objects such as an animal's head. As further described herein, geometric objects 13-18 are mounted onto their respective rods 20 and 22 in a manner which permits each to rotate about the axis formed by rod 20 and 22. As explained herein each geometric object is rotated when a child makes physical contact therewith and wherein said rotation is detected by the apparatus toward triggering the generation of a response to the user. On/off switch 24, activity selector switch 26 and speaker 28 are shown positioned along the lower peripheral edge of housing 12 with the understanding that each is electrically connected to the circuitry located within housing 12. As further disclosed herein, a plurality of momentary contact switches are positioned within and emanate from rods 20 and 22 wherein one switch is positioned on rod 20 and 22 underlying each geometric object. Wires which connect each switch to the electronic circuitry within housing 12 are retained within rods 20 and 22. Rotation of any geometric object 13-18 causes an associated momentary contact switch to be depressed thereby serving to signal which object the user moved.

Although housing 12 is generally rectangular in the illustrated embodiment, housing 12 can be configured to have other shapes and configurations. In addition, although rods 20 and 22 are shown orientated horizontally, rods 20 and 22 may be orientated vertically within the frame formed by housing 12. Still further, rods 20 and 22 need not be carried wholly within a housing or frame as illustrated and may, instead, each be supported at a single end by a base containing the electronic circuitry, power supply, switches and speaker. Furthermore, while rods 20 and 22 are shown orientated in a single plane, a plurality of rods can also be configured so as to be orientated in multiple planes, such forming a three-dimensional square block where the housing is formed by the intersection of respective ends of the rods. Moreover, while each hollow geometric object is illustrated as substantially cubic in shape, other geometric shapes, such as triangles (as illustrated in FIG. 6), spheres (as illustrated in FIG. 7), pentagons, or hexagons, as well as non-geometric shapes may be provided. Indeed, various different shaped objects can be provided within a single apparatus.

The following brief description of various examples of the operation of the present electronic learning apparatus is provided towards enhancing the understanding of the present invention. The following examples are for illustration only, and are not intended to limited the scope of the present invention. Activity selector switch 26 is provided towards permitting the user to place the apparatus 10 into one of multiple modes of operation. For example, a first mode of operation may be passive, wherein no affirmative prompts or requests for a user response or action are presented, but rather the apparatus waits for the user. For example, if the user touches geometric object 13 bearing the letter “A” and object 13 rotates about its center axis to a sufficient degree, the apparatus will provide an audible response in synthesized human speech announcing, for example, the identity of the depicted letter “A”, the alternative sounds made by the letter “A” (a long “A” and a short “A”), and lastly an example of a word which begins with the letter A, such as “apple”. A second mode of operation may be triggered by moving selector switch 26 to an alternative position, whereby an interactive mode is entered. For example, the apparatus using synthesized human speech may prompt the user to locate the letter “C” or alternatively, indicia, such as a picture of a “car”. Accordingly, the user's response to the spoken request is detected by the user making contact with one of the rotatable objects, the movement of which is sensed as further described hereinbelow, towards potentially confirming the identify of the indicia appearing on the block selected, or alternatively, providing the user with an audible response confirming whether or not an appropriate response to the spoken prompt was provided by the user by virtue of moving the correct rotatable structure.

It is further contemplated that blocks 13, 14 and 15 might be red in color, whereas blocks 16, 17 and 18 be blue in color. In such an embodiment, the child may be prompted to identify any rotatable object that is a particular color, such as red. In addition to providing an audible presentation to the user upon the apparatus detecting movement of any one of the rotatable geometric objects, the apparatus may also illuminate one or more light emitting elements positioned around the periphery of the housing 12 or may even illuminate a light emitting element positioned in association with one or more rotatable geometric objects where such objects are either translucent or transparent toward permitting the user to see the light illuminated within.

Accordingly, in the preferred embodiment a microcontroller or microprocessor with memory is provided for controlling the operation of the apparatus and for storing and accessing data associated with a geometric object and/or indicia appearing on one or more surfaces of a geometric object as well as prompts or questions for presentation to the user.

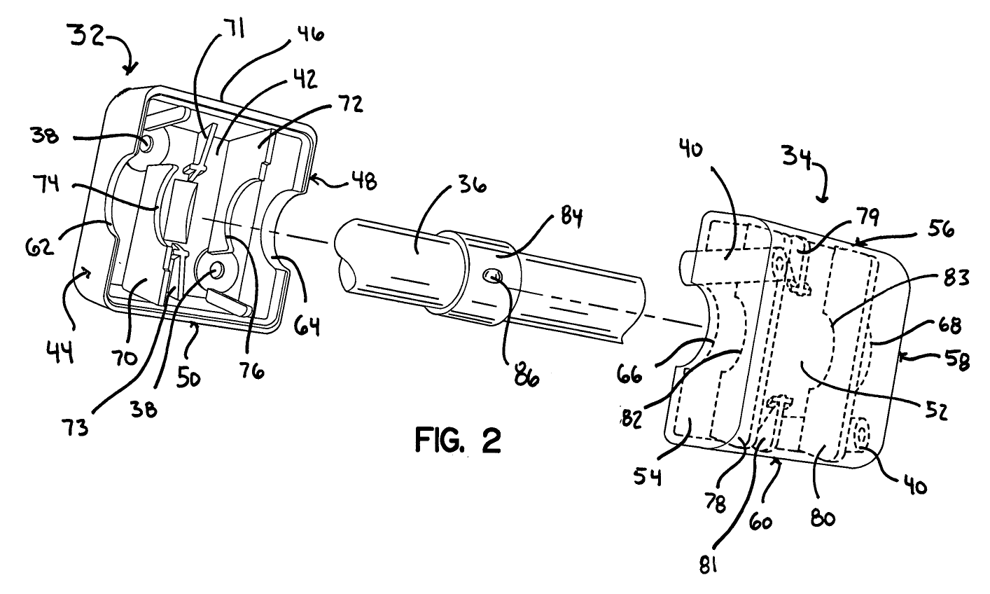

FIG. 2 of the drawings illustrates the construction of a exemplar rotatable geometric object 30 and its assembly upon a rod 36 wherein object 30 is shown cubed shaped. Cube 30 is shown as being formed by the joining together of two half structures 32 and 34 using screws, though adhesive or other joining methods are contemplated. Upon assembly of cube halves 32 and 34, apertures 38 on cube half 32 align with posts 40 on cube half 34, allowing screws (not illustrated) to pass through halves 32 and 34 thereby securing the two halves together to form complete cube 30 (as further illustrated in FIGS. 4 and 5). Cube half 32 comprises an outward facing surface 42, and four sides 44, 46, 48 and 50. Similarly, cube half 34 comprises outward facing surface 52 and sides 54, 56, 58 and 60. Arcuate cutout 62 on side 44 is in concentric alignment with arcuate cutout 64 on side 48 and have the same radius. Arcuate cutout 66 on side 54 of cube half 34 is in concentric alignment with arcuate cut out 68 on side 58.

Internal ribs 70 and 72 internal to cube half 32 are shown substantially parallel to sides 44 and 48. Arcuate cutouts 74 and 76 on ribs 70 and 72 are in concentric alignment with arcuate cutouts 62 and 64 on cube half 32. Similarly, internal ribs 78 and 80 (shown in phantom lines) of cube half 34 are substantially parallel substantially parallel to sides 54 and 58. Arcuate cutouts 82 and 83 (shown in phantom lines) on ribs 78 and 80 are in concentric alignment with arcuate cutouts 66 and 68 on sides 54 and 58.

In the illustrated embodiment, flanges 71 and 73 are provided within the interior facing surface of cube half 32 and extend upwardly from interior facing side of surface 42 and generally parallel to ribs 70 and 72. Similarly, flanges 79 and 81 extend upwardly from interior facing side of surface 52 and generally parallel to ribs 78 and 80.

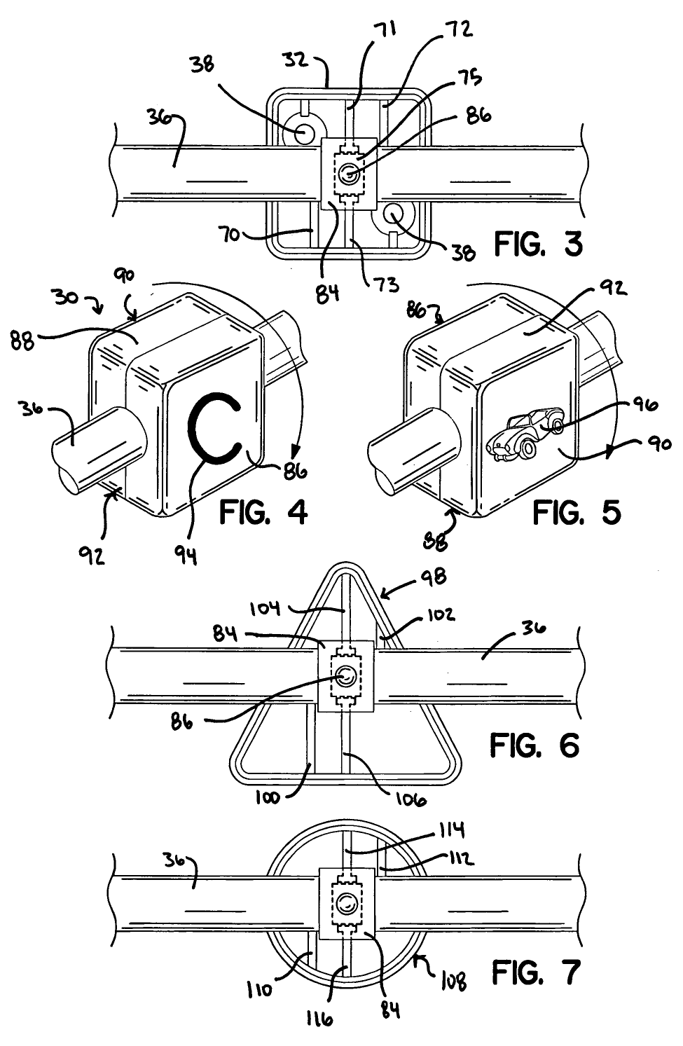

As illustrated in FIGS. 2 and 3, rod 36 includes a outwardly extending sleeve structure 84 which defines the location of each rotatable cube 30 positionable along rod 36. Momentary contact switch 86 is shown extending outwardly from within rod 36 and substantially centered upon sleeve 84. Ribs 70 and 72 are spaced apart a distance slightly larger than the width of sleeve 84 toward allowing cube 30 to freely rotate about rod 36 while preventing lateral movement of the assembled cube 30 with respect to rod 36, as specifically illustrated in FIG. 3. While sleeve 84 is shown having a diameter greater than the diameter of rod 36 which engages with ribs 70, 72, 78 and 80, sleeve 84 alternatively take the form of a groove formed into rod 36 such that rod 36 has a diameter greater than that formed by the base of the groove. In such case, ribs 70, 72, 78 and 80 would extend further away from surfaces 42 and 52 and be spaced closer together so as to engage with the interior facing sides of the groove toward positioning each cube 30 along rod 36 and preventing lateral movement there along.

As illustrated, arcuate cutouts 74, 76 of ribs 70, 72 and cutouts 82, 83 of ribs 78, 80 are formed allowing clearance between the outwardly facing surface of sleeve 84 and the interior facing sides of surfaces 42 and 52 to allow for free rotation of the assembled cube 30 relative to rod 36. Recess 75 is illustrated as being formed into the interior facing side of surface 42 of cube half 32 and in alignment with switch 86 so as to prevent inadvertent depression of momentary switch 86 as cube 30 rotates which may be necessary if cube halfs 23 and 24 are not of equal depth. Similarly, arcuate cutouts 32, 34 of sides 62, 64 and cutouts 66, 68 of sides 54, 58 are formed so as to allow clearance between said cutouts and rod 36 to allow for free rotation of the assembled cube 30 relative to rod 36.

As illustrated in FIGS. 2 and 3, outwardly extending momentary switch 86 is disposed on sleeve 84 of rod 36 and is aligned with flanges 71, 73, 79 and 81. Upon a 180 degree rotation of cube 30 flanges 71 and 79 make contact with the momentary switch 86 and depress switch 86 twice. Upon a further 180 degree rotation of cube 30, flanges 73 and 81 contact and momentarily depress switch 86. Accordingly, each 180 degree rotation of cube 30 is sensed by the momentary closing of switch 86 which using known circuit theory is detected by the circuit within apparatus 10. Moreover, while each half of object 30 is shown as being substantially hollow, each cube half could be molded or otherwise constructed as a substantially solid element into which the aforementioned described interior structures are formed. It is understood that the invention is not limited to a specific number of flanges, though the number of flanges may be largely influenced by the shape of the geometric object. For example, the illustrated flanges may be used to generate two pulses which are sensed by the electronic circuitry.

In the preferred embodiment illustrated in FIGS. 4 and 5, each geometric object 30 includes two main visible surfaces 86 and 90. While there are four opposing display surfaces 86, 88, 90 and 92 on each cube 30, in view of the age of the operator, it may be preferable to utilize no more than two display surfaces as illustrated. In one normal position, surface 86 of cube 30 is generally visible to the user. Upon each 180 degree rotation of cube 30 a different 86 and 90 becomes generally visible. The number and spacing of flanges 71, 73, 79 and 81 and their interaction with a spring-loaded momentary contact switch 86 serves to bias cube 30 into one of two main orientations whereby one of surfaces 86 and 90 are more prominently presented and visible to the user. In another embodiment of the invention, geometric object 30 may comprise an object having a generally triangular cross-sectional shape whereby three main surfaces are available for carrying indicia. The placement of ribs and flanges would then be adjusted to accommodate the triangular shaped object and cause object 30 to have three “normal” positions.

In the preferred embodiment, display surface 86 of cube 30 bears indicia comprising a letter of the English alphabet, such as the letter “C” (FIG. 4) whereas the opposite surface 90 of cube 30 bears indicia comprising a graphic image of an item starting with the letter “C” such as a car 96 (FIG. 5). Accordingly and as suggested above, the user may be prompted by the apparatus to identify a particular letter or an item beginning with a particular letter. In an interactive mode, upon being prompted to locate the letter “C” (either by direct questioning, “Find the ‘C’”, or the spoken phrase asking “What letter does the word ‘car” begin with?”) the user need merely touch and rotate the geometric object bearing the corresponding correct indicia. The user does not need to use an intimidating computer-like keyboard nor possess a high degree of manual dexterity or coordination to appropriately respond to a prompt or question in order to receive the benefits offered by an electronic educational apparatus.

In an alternative embodiment, the geometric object may comprise is a triangle. FIG. 6 illustrates a half triangle 98 positioned upon rod 36. It is understood that the hollow triangle is comprised of two half triangles, only one (98) of which is illustrated in FIG. 6. As before, the width of sleeve 84 on rod 36 is slightly less than the distance between the inner surfaces of ribs 100 and 102 toward preventing lateral movement of the triangle relative to rod 36, while allowing rotational movement of an assembled triangle. Momentary switch 86 on sleeve 84 of rod 36 is shown in alignment with flanges 104 and 106. When the triangular shaped geometric object is rotated relative to rod 36, flanges 100 and 102 come in contact with momentary switch 86 which is then depressed.

In yet another alternative embodiment, the geometric object may comprise a sphere as illustrated in FIG. 7. As in the case of the case of triangle 98, it is understood that the sphere is comprised of two hemispheres, only one (108) of which is illustrated in FIG. 7. As in the case of the first two embodiments, the width of sleeve 84 on rod 36 is slightly less the distance between the inner surfaces of ribs 110 and 112 to prevent lateral movement of the hemisphere relative to rod 36, while allowing rotational movement of the sphere. Momentary switch 86 on sleeve 84 of rod 36 is in alignment with flanges 114 and 116. Thus, when the hollow spherical structure is rotated relative to rod 36, flanges 114 and 116 make contact with momentary switch 84.

While various concepts have been described in detail, it will be appreciated by those skilled in the art that various modifications and alternatives to those concepts could be developed in light of the overall teachings of the disclosure. As such, the particular concepts disclosed are meant to be illustrative only and not limiting as to the scope of the invention which is to be given the full breadth of the appended claims and any equivalents thereof.

1. A user input device for use with an electronic instructional apparatus including a microprocessor based control circuit, a sound generator for presenting audible sounds, an audio speaker, a power supply and control switches contained within a housing, said user input device comprising:
a plurality of rods supported by a housing;
a plurality of switch assemblies positioned along said rods and electrically connected to said control circuit;
a plurality of objects rotationally disposed upon the rods, each object overlying a switch assembly;
at least one flange member provided within each rotational object and aligned with an associated underlying switch assembly such that said flange contacts and, in turn, activates said switch when said object is rotated about the axis formed by said rod;
whereby said control circuit is able to detect which of the plurality of objects is manipulated by the user.

2. The apparatus according to claim 1 wherein each rotational object comprises two sections affixed together and rotatable about an axis formed by said rod.

3. The instructional apparatus according to claim 1 wherein the each switch assembly is positioned within a sleeve which extends outward from said rod.

4. The apparatus according to claim 2 wherein each object has at least two interior ribs which engage with said sleeve toward preventing lateral movement of said object relative to said rod.

6. The apparatus according to claim 2 wherein each object has at least two interior flanges which contact and in turn activate said switch upon each 180 degree rotation of said object about the axis formed by the rod.

7. The apparatus according to claim 1 wherein at least one rotational object has at least one display surface for displaying indicia viewable by a user.

8. The apparatus according to claim 7 wherein 26 rotational objects are provided and spaced apart among 4 rods and wherein each object includes a display surface for displaying one of the letters of the English alphabet.

9. The apparatus according to claim 1 wherein at least one rotational object is geometric in shape.

10. The apparatus according to claim 1 wherein at least one rotational object is in the shape of a cube.

11. The apparatus according to claim 1 wherein at least one rotational object is the shape of a sphere.

12. The apparatus according to claim 1 wherein at least one rotational object is in the shape of a triangle.

13. The apparatus according to claim 1 wherein at least two rotational objects are of different colors

14. A user input device for use with an electronic instructional apparatus including a microprocessor based control circuit, a speech synthesis generator for presenting audible requests for a user response in synthesized human speech, an audio speaker, a power supply and control switches contained within a housing, said input device serving to accept a user's response to said audible requests, said user input device comprising:
a plurality of rods supported by a housing;
a plurality of switch assemblies positioned along said rods and electrically connected to said control circuit;
a plurality of objects rotationally disposed upon the rods, each object overlying a switch assembly;
at least one flange member provided within each rotational object and aligned with an associated underlying switch assembly such that said flange contacts and, in turn, activates said switch when said object is rotated about the axis formed by said rod;
whereby said electronic instructional apparatus is able to detect which of the plurality of objects is manipulated by the user in response to an audible request.

15. The apparatus according to claim 14 wherein each rotational object comprises two sections affixed together and rotatable about an axis formed by said rod.

16. The instructional apparatus according to claim 14 wherein the each switch assembly is positioned within a sleeve which extends outward from said rod.

17. The apparatus according to claim 14 wherein at least one rotational object has at least one display surface for displaying indicia viewable by a user.

18. The apparatus according to claim 1 wherein at least one rotational object is geometric in shape.

19. The apparatus according to claim 1 wherein at least one rotational object is in the shape of a cube.

20. The apparatus according to claim 1 wherein at least two rotational objects are of different colors.
